(19) United States
(12) Patent Application Publication
(10) Pub. No.: US 2003/0152752 A1
(43) Pub. Date: Aug. 14, 2003

(54) Water-resistant and organic solvent-resistant recording sheet

(75) Inventors: Tomofumi Tokiyoshi, Yokohama-shi (JP); Nobuyasu Sasaguri, Chiba-shi (JP); Tetsuya Tanaka, Tokyo (JP)

Correspondence Address: ARMSTRONG,WESTERMAN & HATTORI, LLP, 1725 K STREET, NW, SUITE 1000, WASHINGTON, DC, 20006, US

(73) Assignee: OJI PAPER CO., LTD., Tokyo (JP)

(21) Appl. No.: 10/252,688

(22) Filed: Sep. 24, 2002

(30) Foreign Application Priority Data
Sep. 25, 2001 (JP) 2001-292144
Apr. 2, 2002 (JP) 2002-100313

(51) Int. Cl. B32B 3/00

(52) U.S. Cl. 428/195

(57) ABSTRACT

A recording sheet having a recording layer formed on a substrate sheet (for example, a paper sheet, synthetic resin film or synthetic paper sheet), and including a pigment and a binder which contains a cross-linking reaction product of styrene-acrylic copolymer which preferably has carboxyl groups and is soluble or dispersible in water, with a cross-linking agent, for example, a polyamidepolyamine compound, has excellent resistance to both water and organic solvents and is useful for both dot matrix printers and thermal transfer printers.

### FIELD OF THE INVENTION

The present invention relates to a water-resistant and organic solvent-resistant recording sheet. More particularly, the present invention relates to a recording sheet having excellent resistances to both water and organic solvents and usable for offset printing, gravure printing, dot matrix printing and thermal transfer printing.

### BACKGROUND ART

It is well known that there is a strong demand to realize recording layers having both excellent water-resistance and organic solvent-resistance. For example, in the printing industry, there is a strong demand for recording sheets widely usable in both offset printing and gravure printing. In offset printing, since a dampening water is applied to an offset printing plate, the recording layer which comes into contact with the water-wetted printing plate must have a high water resistance. In gravure printing, however, since images of an ink comprising a pigment dispersed in an organic solvent such as toluene are transferred to the surface of the recording layer, the recording layer must have a high resistance to the organic solvent.

Also, when a recording sheet that comprises a substrate formed from a synthetic paper sheet and a recording layer formed on the substrate sheet, is adhered to a periphery of a drum or can containing organic chemicals and left to stand in the open air, the recording sheet must have both high water resistance and organic solvent resistance. The recording layer having both high water resistance and organic solvent resistance is also widely used in various other ways than the above-mentioned uses.

Generally, for the purpose of enhancing the organic solvent resistance of the recording layer, a water-soluble binder is used. However, the coating film formed from the water-soluble binder has a very low resistance to water and thus it is well known in the recording material industry that production of a recording layer having both high water resistance and organic solvent resistance is difficult. Thus, a plurality of methods of producing the recording layer by radical-polymerizing and cross-linking a monomer or oligomer under irradiation of electron beam or ultraviolet rays, have been attempted. However, these methods are disadvantageous in that a specific apparatus for irradiating the electron beam or the ultraviolet rays is necessary, and specific care and apparatus for safety during the procedure are necessary. Accordingly, a new and cheap recording sheet including a recording layer having both high water resistance and organic solvent resistance is required to be developed.

It is also well known that in printing of labels for industrial uses, barcodes are frequently printed. The printing of barcode or names of goods is mainly carried out by using a dot matrix printer or thermal transfer printer. Generally, in the recording sheet usable for printing using a dot matrix printer, a coating layer formed on a substrate sheet contains pigment particles having a high oil absorption to enhance the color density of printed images. Also, in the recording sheet usable for printing using a thermal transfer printer, a coating layer formed on a substrate sheet is required to have a recording surface exhibiting a high smoothness, to enable the resultant recording sheet to smoothly record the transferred images without interrupting the lines of the images.

Accordingly, in the conventional recording sheet for printing using the dot matrix printer, the pigment particles having a high oil absorption and contained in the coating layer make it difficult for the resulting coating layer to exhibit a high smoothness. If the recording sheet having a coating layer containing the high oil absorption pigment particles and thus exhibiting a low smoothness, is used in a thermal transfer printer, the lines of transferred images are frequently locally cut and it is difficult for the resulting prints to exhibit satisfactory quality.

Also, in a conventional recording sheet usable for printing using a thermal transfer printer, the coating layer formed on a substrate sheet contains pigment particles, for example, kaolin and precipitated calcium carbonate particles which are suitable for forming a surface of the coating layer having a high smoothness. If this type of recording sheets having the above-mentioned pigment particles contained in the coating layer is used for printing using a dot matrix printer, the coating layer exhibits a poor ink absorption, and thus the color density of the printed images is insufficient. As the coating layer has a poor ink absorption, if the resultant prints are adhered to the drums containing the organic chemicals, and soiled by the organic chemicals, for example, and organic solvent, the color density of the ink images in the print is significantly decreased.

Accordingly, there is a strong demand for a new type of recording sheet practically usable for both dot matrix printers and thermal transfer printers and capable of recording thereon clear and accurate images.

### DISCLOSURE OF THE INVENTION

An object of the present invention is to provide a recording sheet having excellent resistance to both of water and organic solvents and usable for offset printing, gravure printing, dot matrix printing and thermal transfer printing and capable of recording thereon clear and accurate images.

The inventors of the present invention have conducted extensive research on a means for solving the above-mentioned problems and found that a recording layer comprising, as a binder, a cross-linked styrene-acrylic copolymer exhibits excellent resistance to both water and organic solvents and is useful for offset printing, gravure printing, dot matrix printing and thermal transfer printing.

Namely, the above-mentioned object can be attained by the water-resistant and organic solvent-resistant recording sheet of the present invention which comprises a substrate sheet and at least one recording layer formed on at least one surface of the substrate sheet and comprising a pigment and a binder,

wherein

the binder of the recording layer comprises a cross-linked styrene-acrylic copolymer.

In the water-resistant and organic solvent-resistant recording sheet of the present invention, the cross-linked styrene-acrylic copolymer may be a cross-linking reaction product of a water-soluble or dispersible styrene-acrylic copolymer having carboxyl groups with a cross-linking agent.

In the water-resistant and organic solvent-resistant recording sheet of the present invention, the cross-linked styrene-acrylic copolymer may be a cross-linking reaction product of the water-soluble or dispersible styrene-acrylic copolymer having carboxyl groups with the cross-linking agent in a mass ratio of 100:1 to 100:50.

In the water-resistant and organic solvent-resistant recording sheet of the present invention, the cross-linking agent preferably comprises at least one polyamidepolyamine compound.

In the water-resistant and organic solvent-resistant recording sheet of the present invention, the polyamidepolyamine compound is preferably selected from addition reaction products of polyamidepolyamines with epihalohydrins.

In the water-resistant and organic solvent-resistant recording sheet of the present invention, the substrate sheet is preferably selected from the group consisting of paper sheets comprising, as a principal component, wood pulps, synthetic resin films, synthetic paper sheets, and composite sheets comprising two or more members of the above-mentioned sheets and films.

In the water-resistant and organic solvent-resistant recording sheet of the present invention, the pigment for the recording layer preferably has an oil absorption of 30 to 150 ml/100 g.

In the water-resistant and organic solvent-resistant recording sheet of the present invention, the pigment for the recording layer preferably comprises at least one member selected from the group consisting of calcined kaolin and precipitated spherical calcium carbonate.

In the water-resistant and organic solvent-resistant recording sheet of the present invention, the recording layer preferably has a surface having a smoothness of 300 seconds or more determined in accordance with Japan TAPPI No. 5.

In the water-resistant and organic solvent-resistant recording sheet of the present invention, the recording layer preferably has a plurality of fine pores having an average pore size of 0.01 to 0.5 μm.

In the water-resistant and organic solvent-resistant recording sheet of the present invention, the recording layer preferably has a plurality of fine pores having a pore volume of 2 to 60 ml, more preferably 3 to 30 ml, per gram of the recording layer, and a pore specific surface area of 100 to 2000 m²/g, more preferably 150 to 1000 m²/g.

In the water-resistant and organic solvent-resistant recording sheet of the present invention, the recording layer is preferably in an amount of 3 to 16 g/m², more preferably 4 to 15 g/m².

A recording sheet having a recording layer formed on a substrate sheet (for example, a paper sheet, synthetic resin film or synthetic paper sheet), and including a pigment and a binder which contains a cross-linked water-soluble or dispersible styrene-acrylic copolymer, with, for example, a polyamidepolyamine compound, has excellent resistance to both water and organic solvents and is useful for both dot matrix printers and thermal transfer printers.

### BEST MODE OF CARRYING OUT THE INVENTION

The water-resistant and organic solvent-resistant recording sheet of the present invention comprises a substrate sheet and at least one recording layer formed on at least one surface of the substrate sheet. The recording layer comprises a pigment and a binder. In the present invention, the binder for the recording layer comprises a cross-linked styrene-acrylic copolymer. The cross-linked styrene-acrylic copolymer is preferably a cross-linking reaction product of a water-soluble or dispersible styrene-acrylic copolymer having carboxyl groups with a cross-linking agent.

In the cross-linking reaction, the water-soluble or dispersible styrene-acrylic copolymer having the carboxyl groups preferably reacts with the cross-linking agent in a mass ratio of 100:1 to 100:50.

The water-soluble or dispersible styrene-acrylic copolymer preferably has carboxyl groups. To obtain a recording layer having high resistance to both water and organic solvents, the styrene-acrylic copolymer preferably is water-soluble or self-emulsible in water or self-dispersible in water even in the absence of a dissolving, emulsifying or dispersing additive. The molecular weight of the styrene-acrylic copolymer is variable in response to the use of the recording sheet.

In the styrene-acrylic copolymer having the carboxyl groups, at least one member of the comonomers from which the copolymer is formed may have at least one carboxyl group or at least one member of the acrylic comonomers may have at least one carboxyl group.

The styrene-acrylic copolymer usable for the present invention includes the copolymeric materials available in trade in the trademarks of, for example, KEICOAT SA-930 and KEICOAT SA-406, made by KINDAI KAGAKUKOGYO K. K. and POLYMALON 1350M and POLYMALON 1354, made by ARAKAWA KAGAKUKOGYO K. K.

In the recording sheet of the present invention, the styrene-acrylic copolymer is contained in a content of 10 to 70 parts by mass per 100 parts by mass of the pigment in the recording sheet. If the content of the styrene-acrylic copolymer is less than 10 parts by mass, the resultant recording sheet may exhibit an insufficient mechanical strength. Also, if the content is more than 70 parts by mass, the content of the pigment in the recording layer may be insufficient to realize the desired effects due to the pigment, and thus the resultant recording layer may exhibit an unsatisfactory recording performance.

In the recording layer of the recording sheet of the present invention, the styrene-acrylic copolymer is cross-linked with a cross-linking agent. The cross-linking agent reacts with the reactive groups of the styrene-acrylic copolymer, such as the carboxyl groups, to form a three-dimensional structure of the cross-linking reaction product of the styrene-acrylic copolymer with the cross-linking agent, which structure enables the resultant recording layer to exhibit excellent resistances to water and organic solvents.

In the present invention, the cross-linking agent preferably comprises at least one polyamidepolyamine compound. The polyamidepolyamine compound is preferably selected from addition reaction products of polyamidepolyamines with epihalohydrins. For example, a polyamidepolyamine compound usable for the present invention is prepared by reacting an aliphatic dibasic acid and/or a derivative thereof with a polyalkylenepolyamine and further reacting the resultant polyamidepolyamine dissolved with an epihalohydrin.

As mentioned above, the polyamidepolyamine compound usable for the present invention is produced by a reaction of an aliphatic dibasic acid or a derivative thereof with a polyalkylenepolyamine.

The aliphatic dicarboxylic acid is preferably selected from malonic acid, succinic acid, glutaric acid, adipic acid, pimelic acid, suberic acid, azelaic acid and sebacic acid. Also, the derivatives of the aliphatic dicarboxylic acids are preferably selected from anhydrides of and esters of lower alcohols, for example, methyl alcohol, with the above-mentioned acids.

The alkylenepolyamines include diethylenetriamine, triethylenetetramine, tetraethylenepentamine and iminobispropylamine.

The polyamidepolyamines are dissolved in water and then reacted with an epihalohydrin to produce an aqueous solution of the resultant polyamidepolyamines-epihalohydrin resin. The epihalohydrin is preferably selected from epichlorohydrin and epibromohydrin.

With respect to the polyamidepolyamine-epihalohydrin compounds, it is important to control the cation value thereof. Generally, the higher the cation value, the more preferable the resultant compound. In the above-mentioned cross-linking compound containing quaternary cationic groups, the total cation value thereof is preferably 0.2 to 5 milli equivalents/g.

The mechanism of the cross-linking reaction of the polyamidepolyamine-epichlorohydrin will be explained below.

When a polyamidepolyamine addition-reacts with epichlorohydrin, a chlorohydrin structure is formed in the resultant compound molecule, cross-linkages are formed between the chlorin atoms of the chlorohydrin structures in the cross-linking compound and the carboxyl groups of the styrene-acrylic copolymer, and intramolecular cross-linkages are formed between the molecules having the chlorohydrine structures formed by the above-mentioned addition reaction, and cross-linkages are formed in the above-mentioned molecules.

The polyamidepolyamine cross-linking agent available in trade includes cross-linking agents in AF series trademarks, made by ARAKAWA KAGAKUKOGYO K. K.

The cross-linking agent is preferably contained in an amount of 1 to 50 parts by mass, preferably 1 to 30 parts by mass, per 100 parts by mass of the styrene-acrylic copolymer in the recording layer. If the amount of the cross-linking agent is less than 1 part by mass, the resultant recording layer may exhibit an insufficient mechanical strength. Also, if the amount of the cross-linking agent is more than 50% by mass, the properties of the pigment contained in the recording layer may be insufficiently exhibited, and thus the resultant recording layer may exhibit an unsatisfactory performance.

In the recording layer of the recording sheet of the present invention, the cross-linking product of the styrene-acrylic copolymer is contained in a content of 10 to 60% by mass, preferably 15 to 50% by mass, based on the total mass of the recording layer.

In the case where the recording sheet is printed, and the resultant prints are used outdoor, it is important that the prints have a high light resistance. Therefore, the binder for the recording layer must be selected from binder resins which are free from yellowing phenomenon even when exposed to light, and preferably has a color difference ΔE of 3 or less, determined by the measurement as mentioned hereinafter.

The recording layer of the recording sheet of the present invention comprises a pigment together with the binder. The content of the pigment in the recording layer is variable in response to the use of the recording sheet. Usually, the pigment is preferably contained in a content of 40 to 90% by mass, more preferably 45 to 85% by mass, on the basis of the total mass of the recording layer. The pigment usable for the recording layer of the recording sheet of the present invention, preferably comprises at least one member selected from mineral pigments, for example, ground calcium carabonate, precipitated calcium carbonate, kaolin, calcined kaolin, delami kaolin, talc, calcium sulfate, barium sulfate, titanium dioxide, zinc oxide, alumina, magnesium carbonate, magnesium oxide, silica, magnesium aluminosilicate, fine particulate calcium silicate, fine particulate magnesium carbonate, fine particulate precipitated calcium carbonate, spherical precipitated calcium carbonate, white carbon, bentonite, zeolite, sericite and smectites; and organic pigments, for example, polystyrene resin, styrene-acrylic copolymer resin, urea resin, melamine resin, acrylic resin, polyvinylidene chloride resin, and benzoguanamine resin pigments which may be in the form of a hollow, filled or perforated particle.

The pigment preferably has an oil absorption of 30 to 150 ml/100 g, more preferably 60 to 120 ml/100 g.

There is no limitation to the particle form and the particle size of the pigment particles usable for the recording layer of the recording sheet of the present invention. Usually, the pigment particles are preferably selected from calcined clay and precipitated calcium carbonate particles having a plate, sphere, spindle, cylinder or cubic form and an average particle size of 0.1 to 5.0 μm. The above-mentioned pigment particles may be subjected to a sand-grinder treatment, in response to the use, to control the particle form and the particle size to thereby to control the smoothness and gloss of the resultant recording layer.

There is no limitation to the sheet substrate for the recording sheet of the present invention. The sheet substrate can be selected from sheet materials in response to the use of the recording sheet. For example, when the substrate sheet is selected from paper sheets, there is no limitation to the production process and the type of the pulps from which the substrate sheet is formed. Namely, the paper sheet for the substrate sheet may be produced from chemical pulps, for example, KP; mechanical pulps, for example, SGP, RGP, BCTMP and CTMP; waste paper pulps; and non-wood pulps, for example, kenaf, bamboo, straw and hemp pulps. Also, organic synthetic fibers, for example, polyamide fibers and polyester fibers; regenerated fibers, for example, polynosic fibers; and inorganic fibers, for example, glass fibers, ceramic fibers and carbon fibers, can be used for the substrate sheet. Also, chorine-free pulps, for example, ECF pulps and TCF pulps are preferably employed for the paper sheets for the substrate sheet of the recording sheet of the present invention. The paper sheet for the substrate sheet may contain a fiber. There is no limitation to the type of the filler. Usually, the filler usable for the substrate sheet preferably comprises at least one member selected from pigments usable for woodfree paper sheets, for example, mineral pigments, for example, kaolin, calcined kaolin, calcium carbonate, calcium sulfate, barium sulfate, titanium dioxide, talc, zinc oxide, alumina, magnesium carbonate, magnesium oxide, silica, white carbon, bentonite, zeolite, sericite and smectiles; and organic resin pigments, for example, polystyrene resin, urea resin, melamine resin, acrylic resin, polyvinylidene chloride resin pigments which may be in the form of a hollow particle filled particle, or perforated particle.

In the recording sheet of the present invention, the substrate sheet may be selected from synthetic resin fibers and synthetic paper sheets.

The synthetic resin films include transparent films, foamed films and white coloring pigment-mixed white films of polyehtylenes (PE), ethylene-vinyl acetate copolymers (EVA), PE-EVA mixtures, linear low density polyethylenes (LLDPE), high density polyethylenes (HDPE), polypropylenes (PP), unoriented polypropylenes (CPP), oriented polypropylenes (OPP), polyvinyl alcohols (PVA), ethylene-vinyl alcohol copolymers (EVOH), polyvinyl chlorides (PVC), polyvinylidene chlorides (PVDC), polystyrenes (PS), polyesters (PET). The synthetic paper sheets include paper-like sheets formed from, as a principal material, PE, PP, PET, PVC or PS.

Among the synthetic paper sheets usable for the substrate sheet, polypropylene synthetic paper sheets comprising a polypropylene resin and an inorganic filler and produced by a biaxially orienting film-forming method (for example, available under a trademark of YUPO, made by YUPO CORPORATION) have a high durability, and, when the recording sheet is used as an adhesive label, a good follow-up property to the surface, particularly curved surface, of a material to which the adhesive label is adhered, and thus, are preferably used for the present invention. The synthetic paper sheets usable for the present invention include those available in trade under the trademarks of YUPO-FFG, YUPO-FGS, YUPO-GFG, YUPO-SGS and YUPO-KPR, made by YUPO CORPORATION.

The paper sheets, synthetic resin films and the synthetic paper sheets may have a multi-layer structure including a barrier layer and/or a undercoat layer or may be combined with each other, to form composite sheets, for example, paper/paper composite sheets, paper/film composite sheets, film/film composite sheets, synthetic paper/synthetic paper composite sheets, synthetic paper/paper composite sheets and synthetic paper/film composite sheets.

In the recording sheet of the present invention, the recording layer optionally further comprises an additional binder, in addition to the cross-linked styrene-acrylic copolymer binder. The additional binder preferably comprises at least one member selected from water-soluble and water-dispersible polymeric materials. The additional binder comprises at least one member selected from, for example, modified starches, for example, oxidized starches, cationic starches, amphoteric starches, enzyme-modified starches, thermochemically modified starches, esterified stanches and etherified starches; cellulose derivatives, for example, carboxymethyl-cellulose and hydroxyethyl-cellulose; natural and semisynthetic polymeric compounds, for example, gelatin, casein, soybean protein and natural rubber; synthetic polymeric compounds, for example, polyvinyl alcohol; polydienes, for example, polyisoprene polyneoprene, polybutadiene; polyalkenes, for example, polybutene, polyisobutene, polypropylene, and polyethylene; vinyl polymers and copolymers, for example, polyvinyl halides, polyvinyl acetate, polystyrene, poly(meth)acrylic acid, poly(meth)acrylate ester, poly(meth)acrylamide, polyvinylether; latices of synthetic rubbers, for example, styrene-butadiene copolymers, methyl methacrylate-butadiene copolymers; polyurethane resins, polyester resins, polyamide resins, olefin-maleic anhydride copolymer resins, and melamine resins. The above-mentioned polymeric materials for the additional binder may be employed alone or in a mixture of two or more thereof.

In the recording sheet of the present invention, the content of the addition binder in the recording layer is preferably 50 parts by mass or less, more preferably 30 parts by mass or less per 100 parts of the cross-linked styrene-acrylic copolymer binder. If the content of the additional binder is more than 50 parts by mass, the object of the present invention cannot be attained by the resultant recording sheet.

In the present invention, the recording layer is formed by coating a coating liquid on the substrate sheet and drying the coated coating liquid layer. The coating liquid to be used for the formation of the recording layer comprises a pigment, the cross-linked copolymer binder, and optionally an additional binder and further an additive. The additive comprises at least one member selected from various functional substances, for example, dispersing agents, for example, polycarboxylic acids and naphthalene sulfonic acid-formaldehyde-condensate dispersing agents; defoaming agents, for example, silicasilicone, silicone, metal soap, amide, ester, polyether, polyglycol, organic phosphate, higher alcohol, sulfonated fatty acid and oil soluble polymer defoaming agents; ultraviolet ray-absorbers; for example, benzophenone and benzotriazole ultraviolet ray-abserbers; photostabilizers, for example, hindered amine photostabilizers; wetting agents, for example, alkylester and alkylamine wetting agents and aliphatic dicarboxylate salts; and surfactants, pH-regulators, viscosity-modifiers, softening agents, gloss-enhancing agents, waxes, mobility-modifiers, electrical insulating agents, stabilizers, antistatic agent, cross-linking agents, sizing agents, fluorescent brightening agents, coloring materials, water-resisting agents, plasticizers, lubricants, preservatives and scenting agents.

The amount of the recording layer is established in response to the use of the recording sheet. Usually, the dry amount of the recording layer is preferably from 2 to 30 g/m², more preferably from 3 to 25 g/m². If the amount of the recording layer is less than 2 g/m², the rough surface of the substrate sheet may not be sufficiently smoothened by the recording layer. Also, if the recording layer amount is more than 30 g/m², the coated layer of the coating liquid for the recording layer may need a long time to dry, and thus the procedure efficiency of the formation of the recording layer may be unsatisfactory, and the mechanical strength of the resultant recording layer may be insufficient and the cost of the recording layer formation may be too high.

The coating procedure for the recording layer can be carried out by using any one or more of the conventional coating apparatuses, for example, blade coaters, air knife coaters, roll coaters, reverse roll coaters, bar coaters, curtain coaters, dice slote coaters, gravure coaters, champlex coaters, brush coaters, two roll-type or metering blade type size press coaters, bill blade coaters, short dwell coaters, and gate roll coaters.

In the recording sheet of the present invention, the surface of the recording layer preferably exhibits a Bekk smoothness of 300 seconds or more, more preferably 500 seconds or more. The recording layer surface having the Bekk smoothness of 300 seconds exhibits a good transferred ink-receiving property in offset printing, a significantly decreased miss-dotting degree in gravure printing, a good transferred wax-receiving property in thermal transfer printing, and an increase in color density of images in dot matrix printing.

In the recording sheet of the present invention, the recording layer may be formed on a front surface or both the front and back surfaces of the substrate sheet, and optionally one or more intermediate layers are formed between the surface of the substrate sheet and the recording layer so that the recording layer has a multi-layered structure. When two recording layers are formed on the two surfaces of the substrate sheet or each recording layer is formed in the multi-layered structure, the coating liquids for the plurality of layers may be the same as each other or different from each other in composition and/or in coating amount. The compositions and coating amounts of the individual layers may be controlled in consideration of the required properties and qualities of the individual layers. In the case where the recording layer is formed only the front surface of the substrate sheet, the back surface of the substrate sheet may be coated with a synthetic resin layer, a back coating layer comprising a pigment and a binder and/or an anti-static layer, to enhance the curl-resistant property, a printing property and a feed and delivery property of the recording sheet.

Further, the substrate sheet, particularly the back surface of the substrate sheet may be processed to impart a functional property, for example, adhesive property, self-adhesive property, magnetic property, flame retardant property, heat-resistant property, water resistant property, oil-resistant property and/or slip-preventing property, to the back surface, to thereby enhance the applicability of the recording sheet to various uses. Particularly, in the self-adhesive property-imparting procedure, there is no limitation to the type of the self-adhesive agents. Various types of self-adhesive agents, for example, acrylic self-adhesive agents comprising a copolymer of an acrylate ester with an acrylic compound having a functional group, rubber self-adhesive agents comprising natural rubber or a mixture of a synthetic rubber with an adhesive-enhancing resin and a softening agent, silicone self-adhesive agents comprising a mixture of a silicone rubber with a silicone resin, can be employed. In view of a low price and a high weather-proofing property, the self-acrylic adhesive agents are preferably employed for the purpose as mentioned above. Among the self-acrylic adhesive agents, from the viewpoint of high adhesion property of the self-adhesive agent to the substrate sheet surface, and an enhanced inner cohesive force of the self-adhesive agent which causes, when a self-adhesive agent-coated surface of a label is adhered to a surface of the substrate sheet and thereafter the adhered label is peeled off from the substrate sheet surface, a remaining amount of the self-adhesive agent on the surface of the substrate sheet to decrease, a two-part cross-linking acrylic self-adhesive agent containing a cross-liking agent is preferred. The cross-linking agent for the self-adhesive agent comprises, for example, an isocyanate compound, melamine, a metal-chelating agent or an epoxy compound.

The recording sheet of the present invention is optionally smoothed by a conventional smoothing apparatus, for example, a super calender, gloss calender, and soft calender in an on-machine procedure or an off-machine procedure. The type of the smoothing apparatus, the number of nipping operations and the smoothing temperature to be applied to the recording sheet can be established with reference to the practice of the usual smoothing procedure.

The recording sheet produced by the process as mentioned above can be used in uses for which both or either of high water resistance and high organic solvent resistance are required. For example, the recording sheet of the present invention is usable as a gravure printing sheet, an offset printing sheet, a substrate for metal-deposited paper sheet, a smudge-proof label sheet for dram can or 20 litter can, an ink jet recording sheet, an electrophotographic recording sheet, thermotransfer recording sheet, and dot matrix printing sheet. Also, after recording or printing, the recording surface may be overlaminated with a transparent film, to protect the recorded images.

In an embodiment of the recording sheet of the present invention, the recording layer have a plurality of fine pores having an average pore size of 0.01 to 0.5 μm, preferably 0.05 to 0.3 μm. The porous recording layer exhibits an enhanced ink-setting property in offset printing, an improvement in prevention of increase in thickness of dots in gravure printing, an enhanced wax-transferring property in thermal transfer printing and an increase in color density of images in dot matrix printing.

Also, in the porous recording layer, the fine pores preferably have a pore volume of 2 to 60 ml per gram of the recording sheet and a pore specific surface area of 100 to 2000 m²/g, more preferably 150 to 1000 m²/g.

Further, the recording layer is preferably in an amount of 3 to 16 g/m², more preferably 4 to 15 g/m².

If the fine pore volume is less than 2 ml per gram of the recording sheet, and/or the pore specific surface area is less than 100 m²/g, when the resultant recording sheet is subjected to a printing procedure using a dot matrix printer, the recording sheet may exhibit an insufficient ink absorption and the color density of the printed ink images may be insufficient.

Also, if the fine pore volume is more than 60 ml per gram of the recording layer, and/or the pore specific surface area is more than 2000 m²/g, when the resultant recording sheet is subjected to a printing procedure using a dot matrix printer, the recording layer exhibit satisfactory ink absorption, whereas the absorbed ink is difficult to be retained on the surface portion of the recording layer, and thus the color density of the printed images is unsatisfactory.

Further, if the porous recording layer is in an amount less than 3 g/m², the porous recording layer may not sufficiently smooth the rough surface of the substrate sheet. Also, if the amount of the porous recording layer is more than 16 g/m², a long time and a large energy may need to complete the formation of the recording layer, and sometimes, the recording layer is insufficiently dried. To complete the recording layer formation, the procedure efficiency may become too low and the procedure cost may become too high.

### EXAMPLES

The present invention will be further explained by the following examples.

### Example 1

As a substrate sheet, a biaxially oriented polypropylene (PP) synthetic paper sheet (trademark: YUPO FPG80, made by YUPO CORPORATION) having a thickness of 80 μm, a density of 0.77 g/cm³ was employed. A front surface of the substrate sheet was coated with a coating liquid having a composition as shown below by using a bar coater and dried, to form a recording layer having a dry solid mass of 7 g/m². A recording sheet was obtained. Composition of coating liquid

| | Component | Part by mass |
|---|---|---|
| Pigment: | Calcined kaolin having an | 100 |
| | oil absorption: 104 ml/100 g. | |
| | (Trademark: Ansilex 93, | |
| | made by ENGELHARD) | |
| Binder: | Styrene-acrylic copolymer | 50 |
| | (Trademark: PM 1350M, | |
| | made by ARAKAWA | |
| | KAGAKUKOGYO K. K.) | |
| Cross-linking agent: | Polyamidepolyamine- | 15 |
| | epichlorohydrin | |
| | (Trademark: AF 251, | |
| | made by ARAKAWA | |
| | KAGAKUKOGYO K. K.) | |

Preparation and Application of Coating Liquid

The calcined kaolin (Ansilex 93) in an amount of 100 parts by mass was mixed with a dispersing agent comprising a sodium polyacrylate (trademark: ARON A-9, made by TOA GOSEI K. K.), and the resultant mixture was dispersed in water by using a Cowless disperser, to prepare a pigment slurry. The pigment slurry was mixed with 50 parts by mass of the binder (PM 1350M) and 15 parts by mass of a cross-linking agent (AF 251), and the mixture was stirred and further mixed with water to provide a coating liquid having a total solid content of 20% by mass.

Printing Test

Table 1 shows the type, particle form, oil absorption and average particle size of the pigment used in the above-mentioned recording sheet, and Table 2 shows the type and content of the binder and the type, cation value and content of the cross-linking agent in the coating liquid, and the average pore size, the smoothness, the AE, the pore volume and the pore specific surface area of the recording layer.

The resultant recording sheet was subjected to a printing procedure using a dot matrix printer or a thermal transfer printer. The performances of the recording sheet was evaluated by the testing methods which will be illustrated hereafter. The test results are shown in Table 3.

Separately, the recording sheet was subjected to a printing procedure using an offset printing machine or a gravure printing machine. The test results are shown in Table 4.

### Example 2

A recording sheet was prepared and tested by the same procedures as in Example 1, with the following exceptions.

As a pigment, precipitated calcium carbonate particles as shown in Table 1 were used, and the contents of the binder and the cross-linking agent were changed as shown below. The test results are shown in Tables 2 to 4.

Composition of coating liquid

| | Component | Part by mass |
|---|---|---|
| Pigment: | Precipitated calcium | 100 |
| | carbonate, | |
| | Oil absorption: 63 ml/100 g. | |
| | (Trademark: TP 123CS, | |
| | made by OKUTAMA | |
| | KOGYO K. K.) | |
| Binder: | Styrene-acrylic copolymer | 40 |
| | (Trademark: PM 1350M, | |
| | made by ARAKAWA | |
| | KAGAKUKOGYO K. K.) | |
| Cross-linking agent: | Polyamidepolyamine- | 10 |
| | epichlorohydrin | |
| | (Trademark: AF 251, | |
| | made by ARAKAWA | |
| | KAGAKUKOGYO K. K.) | |

### Example 3

A recording sheet was prepared and tested by the same procedures as in Example 1, with the following exceptions.

As a pigment, a clay as shown in Table 1 was employed, and the contents of the binder and the cross-linking agent in the coating liquid were changed as shown below. The test results are shown in Tables 2 to 4.

Composition of Coating Liquid

| | Component | Part by mass |
|---|---|---|
| Pigment: | Clay, | 100 |
| | Oil absorption: 46 ml/100 g. | |
| | (Trademark: UW90, | |
| | made by ENGELHARD) | |
| Binder: | Styrene-acrylic copolymer | 30 |
| | (Trademark: PM 1350M, | |
| | made by ARAKAWA | |
| | KAGAKUKOGYO K. K.) | |
| Cross-linking agent: | Polyamidepolyamine- | 5 |
| | epichlorohydrin | |
| | (Trademark: AF 251, | |
| | made by ARAKAWA | |
| | KAGAKUKOGYO K. K.) | |

### Example 4

A recording sheet was prepared and tested by the same procedures as in Example 1, with the following exceptions.

For the substrate sheet, the biaxially oriented PP synthetic paper sheet was replaced by a pulp paper sheet as shown below. In the coating liquid, the contents of the binder and the cross-linking agent were changed as shown below. The test results are shown in Tables 2 to 4.

Preparation of Pulp Paper Sheet

A hardwood kraft pulp (LBKP) having a Canadian Standard freeness (CSF) of 450 ml in an amount of 100 parts by mass were mixed with 0.05 part by mass of an inner sizing agent consisting of alkenyl succinic anhydride (Trademark: FIVERUN 81K, made by ARAKAWA KAGAKUKOGYO K. K.), 0.7 part by mass a fixing agent consisting of an cationic starch (Trademark: CATO F, made by NIHON NSC K. K.), and 0.5 part by mass of aluminum sulfate and then with 10 parts by mass of calcium carbonate. The resultant mixture was further mixed with white water to provide a paper-forming pulp slurry having a pH value of 7 and a solid content of 0.8% by mass. The pulp slurry was fed into a paper-producing procedure using a Fourdrinier paper-machine. The resultant wet paper sheet was coated with a sizepress liquid containing 6% by mass of a sizing agent consisting of oxidized starch (Trademark: ACE A, made by OJI CORN STARCH K. K.) and dried by using a sizepress machine to size the paper sheet with the sizing agent in a dry solid amount of 2 g/m². The resultant paper sheet was subjected to a smoothing procedure using a machine calender to control the Bekk smoothness of the paper sheet to 50 seconds. A substrate paper sheet having a basis weight of 80 g/m² was obtained.

Composition of Coating Liquid

| | Component | Part by mass |
|---|---|---|
| Pigment: | Calcined kaolin having an | 100 |
| | oil absorption: 104 ml/100 g. | |
| | (Trademark: Ansilex 93, | |
| | made by ENGELHARD) | |
| Binder: | Styrene-acrylic copolymer | 50 |
| | (Trademark: PM 1350M, | |
| | made by ARAKAWA | |
| | KAGAKUKOGYO K. K.) | |
| Cross-linking agent: | Polyamidepolyamine- | 20 |
| | epichlorohydrin | |
| | (Trademark: AF 251, | |
| | made by ARAKAWA | |
| | KAGAKUKOGYO K. K.) | |

Formation of Recording Layer on Substrate Sheet

The resultant coating liquid was coated, by using bar coaters, on the front and back surfaces of the substrate sheet in a dry amount of 12 g/m² per surface of the substrate sheet, and dried to form front and back recording layers. The resultant coated sheet was subjected to a press-nipping procedure using a nipping roller machine having a metal roll and an elastic roll, to adjust the Bekk smoothness of the front and back surfaces of the sheet to 1000 seconds. A recording sheet having a basis mass of 104 g/m². The test results are shown in Tables 2 to 4.

### Example 5

A recording sheet was prepared and tested by the same procedures as in Example 1, with the following exceptions.

As a pigment, precipitated calcium carbonate as shown in Table 1 was employed, and the contents of the binder and the cross-linking agent were changed as shown below. The test results are shown in Tables 2 to 4.

Composition of Coating Liquid

| | Component | Part by mass |
|---|---|---|
| Pigment: | Precipitated calcium | 100 |
| | carbonate, | |
| | Oil absorption: 30 ml/100 g. | |
| | (Trademark: ED III, | |
| | made by YONESHO | |
| | SEKKAIKOGYO K. K.) | |
| Binder: | Styrene-acrylic copolymer | 40 |
| | (Trademark: PM 1350M, | |
| | made by ARAKAWA | |
| | KAGAKUKOGYO K. K.) | |
| Cross-linking agent: | Polyamidepolyamine- | 10 |
| | epichlorohydrin | |
| | (Trademark: AF 251, | |
| | made by ARAKAWA | |
| | KAGAKUKOGYO K. K.) | |

Comparative Example 1

A recording sheet was prepared and tested by the same procedures as in Example 1, except that the recording layer contained no cross-linking agent. The test results are shown in Tables 2 to 4.

### Example 2

A recording sheet was prepared and tested by the same procedures as in Example 1, with the following exception.

The styrene-acrylic copolymer (trademark: PM 1350M) used as a binder was replaced by a stylene-butadiene copolymer latex (trademark: T 2550K, made by NIHON GOSEIGOMU K. K.). The test results are shown in Tables 2 to 4.

Test and Evaluation

[Oil Absorption of Pigment]

The oil absorption of the pigment was measured in accordance with JIS K 5101.

[Average Size of Pores, Pore Volume and Pore Specific Surface Area of Recording Layer]

The average pore size, pore volume, and pore specific surface area of the recording layer were measured by a mercury penetration method using a micrometrix poresizer 9320 (trademark, made by SHIMAZU SEISAKUSHO).

The back surface of the recording sheet was sealed by a viscose adhesive tape (trademark: CELLOTAPE), to avoid the influence of the back surface on the measurement.

[Average Particle Size of Pigment]

The average particle size of the pigment was measured by using a centrifugal separation type particle size meter (trademark: CP-50, made by SHIMAZU SEISAKUSHO) and calculated on the basis of area.

[Color Difference ΔE]

Weathering tester: Trademark: SUPER UV TESTER SUV-W13, made by IWASAKI DENKI K. K.

Testing Conditions:

(1) A testing sample was placed inside of the tester.

Lighter irradiation time: 5 hours

During the irradiation, the inside of the tester was heated by an inner heater to a temperature of 83° C. and a relative humidity of 50% RH.

(2) The light and heater were switched off, the inside of the tester was cooled, for 2 hours by working a fan, and the temperature of the inside of the tester was decreased stepwise from 70° C. to 30° C.

(3) The temperature of the inside of the tester was further decreased stepwise so that the relative humidity of the inside of the tester was increased to 95% RH or more and dew condensation occurred on the testing sample, and the this conditions are kept for 2 hours.

The testing cycle consisting of the steps (1), (2) and (3) as mentioned above, was repeated 8 times.

Thereafter, the colors (E), namely L*-value, a*-value and b*-value, of the testing sample before and after the weathering test were measured and represented in accordance with JIS Z 8729. The color difference AE of the testing sample before and after the weathering test was determined.

E=(a*²+b*²)^{1/2}

[Bekk Smoothness of Recording Sheet]

The Bekk smoothness of the surface of the recording layer was determined in accordance with JAPAN TAPPI No. 5.

[Printing Test by Dot Matrix Printer]

(Quality of Printed Images)

The recording sheet was subjected to a printing by a dot matrix printer (trademark: PC-PR101/63, made by NEC, using an ink ribbon trademark: PC201G-01, made by NEC). The printed image was checked by naked eye by using an optical microscope at an magnification of 30. The degree of missing dots in the observed images was evaluated as follows.

| Class | Missing dots |
|---|---|
| 4 | No missing dots found. |
| | Very good |
| 3 | Missing dots substantially not |
| | found. Good |
| 2 | Certain missing dots found. |
| | Difficult in practical use |
| 1 | A significant number of missing dots |
| | found. Very bad |

(Resistance to Rubbing)

As a tester for resistance to rubbing, a GAKUSHIN-type tester (SUGA tester) FR-II was employed.

(1) Resistance to Organic Solvent

Toluene was dropped onto the printed images, a tissue paper sheet was brought into contact with the toluene-wetted images on the recording layer and the image portions of the recording layer were rubbed with the tissue paper-sheet under a load of 70 g/cm² 200 times. It was observed whether partial missings or peelings of the image portions of the recording layer occurred.

The resistance of the printed recording layer to the organic solvent was evaluated as follows.

| Class | Results of rubbing |
|---|---|
| 4 | No defect and peeling of the printed |
| | recording layer found. |
| | Very good |
| 3 | Defect and peeling of the printed |
| | recording layer substantially not |
| | found. Good |
| 2 | Certain defect and peeling of the |
| | printed recording layer found. |
| | Practical use is difficult |
| 1 | Significant defect and peeling of |
| | the printed recording sheet found. |
| | Bad |

(2) Resistance to Water

Water was dropped onto images printed on the recording layer of the recording sheet, a gauze was brought into contact with the water-wetted image portions of the recording layer and the image portions were rubbed by the gauze under a load of 70 g/cm² 500 times. Then it was observed whether partial missings and peelings of the image portions of the recording layer occurred.

The resistance of the printed recording layer to water was evaluated as follows.

| Class | Results of rubbing |
|---|---|
| 4 | No missing dots or no peeling of the |
| | printed recording layer found. |
| | Very good |
| 3 | Missing dots and no peeling of the |
| | printed recording layer |
| | substantially not found. Good |
| 2 | Certain missing dots and no peeling |
| | of the printed recording layer |
| | found. |
| | Practical use is difficult |
| 1 | Significant missing dots and no |
| | peeling of the printed recording |
| | layer found. Bad |

[Printing Test by Thermal Transfer Printer]

(1) Evaluation of Quality of Printed Images

The printed images are formed by a thermal transfer printer, mode: B-30, made by TEC, using an ink ribbon (trademark: TR4085, made by SONY CHEMICAL K. K.), and checked by naked eye by using an optical microscope at a magnification of 30. The degrees of missing dots and thickening of dots in the checked images were evaluated as follows

| Class | Dot-missing |
|---|---|
| 4 | No missing and thick dots found. |
| | Very good |
| 3 | Missing and thick dots substantially |
| | not found. |
| | Good |
| 2 | Certain missing and thick dots |
| | found. |
| | Difficult for practical use |
| 1 | Significant missing and thick dots |
| | found. |
| | Very bad |

(2) Resistance to Rubbing

(a) Resistance to Organic Solvent

Toluene was dropped onto the printed images, a gauze was brought into contact with the toluene-wetted images on the recording layer, and the image portions of the recording layer were rubbed with the gauze 200 times under a load of 70 g/cm². The degrees of missing and peeling of the printed recording layer were checked by naked eye. The results are evaluated as follows

| Class | Resistance to rubbing |
|---|---|
| 4 | No defect or peeling of the printed |
| | recording layer found. |
| 3 | Defect and peeling of the printed |
| | recording layer substantially not |
| | found. |
| | Good |
| 2 | Certain defect and peeling of the |
| | printed recording layer found. |
| | Practical use is difficult |
| 1 | Significant defect and peeling of the |
| | printed recording layer found. |
| | Bad |

(b) Resistance to Water

Water was dropped onto the printed images, a gauze was brought into contact with the water-wetted images on the recording layer, and the image portions of the recording layer were rubbed with the gauze 500 times under a load of 70 g/cm². The degrees of missing and peeling of the printed recording layer were checked by naked eye. The results are evaluated as follows

| Class | Resistance to rubbing |
|---|---|
| 4 | No defect and peeling of the printed |
| | recording layer found. |
| 3 | Defect and peeling of the printed |
| | recording layer substantially not |
| | found. |
| | Good |
| 2 | Certain defect and peeling of the |
| | printed recording layer found. |
| | Practical use is difficult |
| 1 | Significant defect and missing of |
| | the printed recording layer found. |
| | Bad |

[Printing Test by Offset Printing Machine]

(1) Reproducibility of dots and halftone dots The offset-printed images on the recording layer are observed by naked eye and the dot-missing prevention property and reproducibility of the dots are evaluated as follows.

(a) Missing dots

| Class | Quality of dots |
|---|---|
| 4 | No defect in dots found. |
| | Excellent |
| 3 | Slight defects in dots found. |
| | Practically usable |
| 2 | Certain defects in dots found. |
| | Practically less usable |
| 1 | Significant defects in dots found. |
| | Bad. Practically useless |

(b) Dot-reproducibility

| Class | Dot-reproducibility |
|---|---|
| 4 | No blotting and enlarging of dots |
| | found |
| | Excellent |
| 3 | Slight blotting and enlarging of |
| | dots found |
| | Practically usable |
| 2 | Certain blotting and enlarging of |
| | dots found. |
| | Practically less usable |
| 1 | Significant blotting and enlarging |
| | of dots are found. |
| | Practically useless. Bad |

(Resistance to piling of recording layer on printing
plate in practical printing machine)

| Class | Resistance to piling |
|---|---|
| 4 | No accumulation of portions |
| | recording layer on printing plate is |
| | found. |
| | Printing operationality is good |
| 3 | Slight accumulation of portions of |
| | recording layer on printing plate is |
| | found. |
| | The printed images are not affected. |
| | Practically usable |
| 2 | Certain accumulation of portions of |
| | recording layer on printing plate is |
| | found. The printed images are |
| | affected by the accumulation. |
| | Practically less usable |
| 1 | Significant accumulation of portions |
| | of recording layer on printing plate |
| | is found. |
| | The printed images are affected by |
| | the accumulation. |
| | Practically useless. Bad |

[Printing Test by Gravure Printing Machine]

(Dot-Missing and Dot Reproducibility)

The recording sheet was printed by the gravure printing machine in accordance with JAPAN TAPPI, No. 24m “Testing Method on Gravure Printing Aptitude of Paper”. The resultant print was observed by naked eye and evaluated into the following four classes.

(a) Dot missing

| Class | Quality of dots |
|---|---|
| 4 | No defect in dots is found. |
| | Excellent |
| 3 | Slight defects in dots are found. |
| | Practically usable |
| 2 | Certain defects in dots are found. |
| | Practically less usable |
| 1 | Significant defects in dots are |
| | found. |
| | Bad. Practically useless |

(b) Dot-reproducibility

| Class | Dot-reproducibility |
|---|---|
| 4 | No blotting and enlarging of dots |
| | are found |
| | Excellent |
| 3 | Slight blotting and enlarging of |
| | dots are found |
| | Practically usable |
| 2 | Certain blotting and enlarging of |
| | dots are found. |
| | Practically less usable |
| 1 | Significant blotting and enlarging |
| | of dots are found. |
| | Practically useless. Bad |

(Resistance to piling of recording layer on printing
plate in practical printing machine)

| Class | Resistance to piling |
|---|---|
| 4 | No accumulation of portions |
| | recording layer on gravure plate is |
| | found. |
| | Printing operationality is good |
| 3 | Slight accumulation of portions of |
| | recording layer on gravure plate is |
| | found. |
| | The printed images are not affected. |
| | Practically usable |
| 2 | Certain accumulation of portions of |
| | recording layer on gravure plate is |
| | found. The printed images are |
| | affected by the accumulation. |
| | Practically less usable |
| 1 | Significant accumulation of portions |
| | of recording layer on gravure plate |
| | is found. |
| | The printed images are affected by |
| | the accumulation. |
| | Practically useless. Bad |

TABLE 1

| | | Item | | | |
|---|---|---|---|---|---|
| | | Pigment | | | |
| | | | Form of pigment | Oil absorption | Average particle |
| Example No. | | Type of pigment | particles | (ml/100 g) | size (μm) |
| Example | 1 | Calcined kaolin | Amorphous | 104 | 0.9 |
| | 2 | Precipitated | Spindle sharp | 63 | 1.6 |
| | | calcium carbonate | | | |
| | 3 | Clay | Hexagonal plate | 46 | 0.7 |
| | | | sharp | | |
| | 4 | Calcined kaolin | Amorphous | 104 | 0.9 |
| | 5 | Precipitated | Globular sharp | 30 | 3.0 |
| | | calcium carbonate | | | |
| Comparative | 1 | Calcined kaolin | Amorphous | 104 | 0.9 |
| Example | 2 | Calcined kaolin | Amorphous | 104 | 0.9 |

TABLE 2

| | | Item | | | | | | | | | |
|---|---|---|---|---|---|---|---|---|---|---|---|
| | | Binder | | Cross-linking agent | | | | | | | |
| | | | Amount | | | Amount | | | Pore | | |
| | | | (*)₁ | | Total cation | (*)₁ | Average | | specific | | |
| | | | (Part | | value | (Part | pore | Pore | surface | Bekk | |
| | | | by | | (multi- | by | size | volume | area | smoothness | |
| Example No. | | Type | mass) | Type | equivalent/g) | mass) | (μm) | (ml/g) | (m²/g) | (second) | ΔE |
| Example | 1 | Styrene- | 50 | Polyamide- | 4 | 15 | 0.08 | 7.0 | 330 | 500 | 0.5 |
| | | acrylic | | polyamine | | | | | | | |
| | | copolymer | | | | | | | | | |
| | 2 | Styrene- | 40 | Polyamide- | 4 | 10 | 0.09 | 3.5 | 120 | 500 | 0.5 |
| | | acrylic | | polyamine | | | | | | | |
| | | copolymer | | | | | | | | | |
| | 3 | Styrene- | 30 | Polyamide- | 4 | 5 | 0.05 | 2.5 | 100 | 700 | 0.5 |
| | | acrylic | | polyamine | | | | | | | |
| | | copolymer | | | | | | | | | |
| | 4 | Styrene- | 50 | Polyamide- | 4 | 20 | 0.08 | 11.0 | 500 | 1000 | 0.6 |
| | | acrylic | | polyamine | | | | | | | |
| | | copolymer | | | | | | | | | |
| | 5 | Styrene- | 50 | Polyamide- | 4 | 15 | 0.20 | 5.5 | 300 | 400 | 0.5 |
| | | acrylic | | polyamine | | | | | | | |
| | | copolymer | | | | | | | | | |
| Comparative | 1 | Styrene- | 50 | — | — | — | 0.08 | 6.5 | 300 | 500 | 0.5 |
| Example | | acrylic | | | | | | | | | |
| | | copolymer | | | | | | | | | |
| | 2 | Styrene- | 50 | — | — | — | 0.08 | 6.5 | 300 | 500 | 1.5 |
| | | butadiene | | | | | | | | | |
| | | copolymer | | | | | | | | | |

[Note]
*₁ . . . Per 100 parts by mass of pigment

TABLE 3
Item

| | | Dot matrix printing | | | Thermal transfer printing | | |
|---|---|---|---|---|---|---|---|
| | | | Resistance to rubbing | | | Resistance to rubbing | |
| | | | Organic | | | Organic | |
| | | Clarity of | solvent | Water | Clarity of | solvent | Water |
| Example No. | | images | resistance | resistance | images | resistance | resistance |
| Example | 1 | 4 | 3 | 4 | 4 | 3 | 4 |
| | 2 | 3 | 4 | 4 | 3 | 4 | 4 |
| | 3 | 3 | 4 | 4 | 3 | 4 | 4 |
| | 4 | 4 | 4 | 4 | 4 | 4 | 4 |
| | 5 | 4 | 3 | 3 | 4 | 3 | 3 |
| Comparative | 1 | 4 | 2 | 2 | 4 | 2 | 2 |
| Example | 2 | 4 | 1 | 1 | 4 | 1 | 1 |

TABLE 4

| | | Item | | | | | |
|---|---|---|---|---|---|---|---|
| | | Offset printing | | | Gravure printing | | |
| | | Missing dot | Dot- | Piling | Missing dot | Dot- | Piling |
| Example No. | | prevention | reproducibility | prevention | prevention | reproducibility | prevention |
| Example | 1 | 3 | 4 | 3 | 4 | 4 | 3 |
| | 2 | 4 | 4 | 4 | 3 | 3 | 4 |
| | 3 | 4 | 4 | 4 | 4 | 3 | 4 |
| | 4 | 3 | 4 | 4 | 4 | 4 | 4 |
| | 5 | 3 | 4 | 3 | 4 | 4 | 3 |
| Comparative | 1 | 3 | 4 | 2 | 4 | 4 | 2 |
| Example | 2 | 3 | 4 | 1 | 4 | 4 | 1 |

### Example 6

A release paper sheet having a releasing agent layer was prepared by coating a surface of a glassine paper sheet having a basis weight of 82 g/m² with 1.0 g/m² of a silicone releasing agent (trademark: KS-772, made by SHINETSU KAGAKU KOGYO K. K.) by using a Mayer bar.

Separately, a self-adhesive agent was prepared by solution-polymerizing 85 parts by mass of butyl acrylate and 5 parts by mass of acrylic acid in the presence of 1 part by mass of an initiating agent, consisting of benzoyl peroxide, in polymerization medium consisting of ethyl acetate, to produce a main component of the target self-adhesive agent having a concentration of 40% by mass; and mixing the main component of the self-adhesive agent with 2 parts by mass of a cross-linking agent consisting of multi-functional aromatic isocyanate compound (trademark: COLONAT L, made by NIHON POLYURETHANE KOGYO K. K.).

The self-adhesive agent was coated on the releasing agent layer of the release paper sheet by using an applicator and dried at a temperature of 100° C. for 2 minutes to form a self-adhesive layer having a dry mass of 25 g/m².

The self-adhesive layer on the release sheet was adhered onto a surface of the recording sheet prepared in Example 1 opposite to the recording surface thereof, to provide a composite sheet. Recording composite labels were prepared from the composite sheet.

The recording surfaces of the composite sheet labels were subjected to printing tests using the dot-matrix printer and the thermal transfer printer.

The printed recording labels having the self-adhesive layer were separated from the release sheet and adhered onto peripheries of drums containing chemicals and left outdoors for one year as a weathering test. The changes in the printed images during the testing period were checked by the naked eye. Also, the color difference ΔE between the start and the end of the weathering test was measured.

It was confirmed that the color difference ΔE during the weathering test period was 0.8. Also, it was confirmed that after the weathering test, no missing dots of the dot matrix printed images and the thermal transfer printed images and no defect and peeling of the printed recording layer were found. Also, no partial separation of the adhered labels from the drum peripheries was found.

### APPLICABILITY OF THE INVENTION

The recording sheet of the present invention has high resistances to water and organic solvent and appropriate smoothness and porosity and thus is useful for all of offset printing, gravure printing, dot matrix printing and thermal transfer printing, can record thereon clear images and is usable as a label sheet to be adhered to drums or cans containing an aqueous or organic chemical substance.

1. A water-resistant and organic solvent-resistant recording sheet comprising a substrate sheet and at least one recording layer formed on at least one surface of the substrate sheet and comprising a pigment and a binder,
wherein
the binder of the recording layer comprises a cross-linked styrene-acrylic copolymer.

2. The water-resistant and organic solvent-resistant recording sheet as claimed in claim 1, wherein the cross-linked styrene-acrylic copolymer is a cross-linking reaction product of a water-soluble or dispersible styrene-acrylic copolymer having carboxyl groups with a cross-linking agent.

3. The water-resistant and organic solvent-resistant recording sheet as claimed in claim 2, wherein the cross-linked styrene-acrylic copolymer is a cross-linking reaction product of the water-soluble or dispersible styrene-acrylic copolymer having carboxyl groups with the cross-linking agent in a mass ratio of 100:1 to 100:50.

4. The water-resistant and organic solvent-resistant recording sheet as claimed in claim 2, wherein the cross-linking agent comprises at least one polyamidepolyamine compound.

5. The water-resistant and organic solvent-resistant recording sheet as claimed in claim 4, wherein the polyamidepolyamine compound is selected from addition reaction products of polyamidepolyamines with epihalohydrins.

6. The water-resistant and organic solvent-resistant recording sheet as claimed in claim 1, wherein the substrate sheet is selected from the group consisting of paper sheets comprising, as a principal component, wood pulps, synthetic resin films, synthetic paper sheets, and composite sheets comprising two or more members of the above-mentioned sheets and films.

7. The water-resistant and organic solvent-resistant recording sheet as claimed in claim 1, wherein the pigment for the recording layer has an oil absorption of 30 to 150 ml/100 g.

8. The water-resistant and organic solvent-resistant recording sheet as claimed in claim 1, wherein the pigment for the recording layer comprises at least one member selected from the group consisting of calcined kaolin and precipitated spherical calcium carbonate.

9. The water-resistant and organic solvent-resistant recording sheet as claimed in claim 1, wherein the recording layer has a surface having a smoothness of 300 seconds or more determined in accordance with Japan TAPPI No. 5.

10. The water-resistant and organic solvent-resistant recording sheet as claimed in claim 1, wherein the recording layer have a plurality of fine pores having an average pore size of 0.01 to 0.5 μm.

11. The water-resistant and organic solvent-resistant recording sheet as claimed in claim 1, wherein the recording layer has a plurality of fine pores having a pore volume of 2 to 60 ml per gram of the recording layer, and a pore specific surface area of 100 to 2000 m²/g.

12. The water-resistant and organic solvent-resistant recording sheet as claimed in claim 11, wherein the recording layer is in an amount of 3 to 16 g/m².

13. The water-resistant and organic solvent-resistant recording sheet as claimed in any one of claims 1 to 12, wherein a recording layer is formed on the front surface of the substrate sheet and a self-adhesive layer is formed on the back surface of the substrate sheet.
